(19) United States
(12) Patent Application Publication
(10) Pub. No.: US 2025/0342236 A1
(43) Pub. Date: Nov. 6, 2025

(54) IN-EAR AUTHENTICATION

(71) Applicant: Microsoft Technology Licensing, LLC, Redmond, WA (US)

(72) Inventor: Ahilan ANANTHA KRISHNAN, Mountain View, CA (US)

(21) Appl. No.: 18/653,429

(22) Filed: May 2, 2024

(51) Int. Cl. G06F 21/32

(52) U.S. Cl. CPC G06F 21/32

(57) ABSTRACT

Methods, systems, and computer program products are provided for biometric authentication and personalization earbuds. Biometric authentication earbuds provide enhanced security and/or personalization for personal audio devices, such as a cell phone host device transmitting wireless audio information to the biometric authentication and personalization earbuds. Biometric authentication and personalization earbuds determine and use user-specific (e.g., unique) biometric markers, such as the shape of the inner and outer ear detected by pressure sensors, blood flow in the ear detected by blood flow sensors, and/or the ear's auditory response detected by acoustic sensors, to authenticate users, enable or adjust earbud operation(s) based on authentication, and/or personalize earbud operation(s) for users. Upon insertion, the earbuds automatically authenticate the user by analyzing the user's biometric markers in comparison to one or more authenticated user biomarker profiles.

### BACKGROUND

“Authentication” is the act of proving an assertion, such as the identity of a computer system user. While identification is the act of indicating identity, authentication is the process of verifying that identity. Various techniques are used in computer systems to perform authentication of a user, such as by receiving a passcode provided by the user, detecting a biometric factor associated with the user, a communication exchanged with a device of the user, etc. The received factor of the user is compared to a known factor of the user to authenticate the user. “Single-factor” authentication may be performed, which uses a single received aspect (e.g., a passcode) to authenticate the user, or “multi-factor” authentication may be performed, which uses multiple received aspects (e.g., passcode and fingerprint) to authenticate the user.

Headphones are a pair of small loudspeaker drivers worn on or around the head to supply sound to a user's ears. Headphones include electroacoustic transducers, which convert an electrical signal to a corresponding sound. Earbuds (also known as earpieces) are a type of headphone formed of a pair of individual units that are inserted into the ear canal of the user when in use. A host device, such as a smart phone, may be communicatively coupled to earbuds to provide the electrical signals that the earbuds convert to sound.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for biometric authentication and personalization using earbuds. Biometric authentication earbuds provide enhanced security and/or personalization for personal audio devices, such as a cell phone host device transmitting wireless audio information to the biometric authentication and personalization earbuds. Biometric authentication and personalization earbuds determine and use user-specific biometric markers to authenticate users, enable or adjust earbud operation(s) based on authentication, and/or personalize earbud operation(s) for users. For example, upon insertion, earbuds automatically authenticate the user by analyzing the user's biometric markers in comparison to one or more authenticated user biomarker profiles.

In one aspect, systems, methods, and computer program products for user authorization, identification, or access, comprise: generating pressure samples by a pressure sensor of the earbud inserted at least partially in an ear canal of an ear a first user; generating a first biometric marker from the pressure samples; generating a first comparison result based on a comparison of the first biometric marker with a first stored biometric marker associated with an authorized user of the earbud, the first stored biometric marker indicative of an in-ear biometric profile of the authorized user; performing an authentication of the first user based at least on the first comparison result and/or performing a personalization of the ear bud based at least on the first comparison result.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows an example of a biometric authentication and personalization earbud communicatively coupled/connected to one or more host devices with which a user may interact, according to an embodiment.

FIG. 2 shows an example of an outer ear.

FIG. 3 shows an example of a cross-section of an ear.

FIG. 4 shows examples of outer case and inner case shapes that may be populated with one or more types of authentication and personalization sensors to detect user-specific ear features, according to an embodiment.

FIG. 5 shows an example of a biometric authentication and personalization earbud with an ear tip configured to apply pressure to sensors based on ear shape, according to an example embodiment.

FIG. 6 shows an example of a biometric authentication and personalization earbud with an ear tip configured to apply pressure to sensors based on ear shape, according to an example embodiment.

FIGS. 7A and 7B show flowcharts of example methods of operation of a biometric authentication and personalization earbud, according to an example embodiment.

FIG. 8 shows a block diagram of an example computing device that may be used to implement embodiments.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Earbuds (also known as earpieces) are a type of headphone formed of a pair of individual units that are inserted into the ear canal of the user when in use. A host device, such as a smart phone, may be communicatively coupled to earbuds. Traditional earbuds lack sophisticated user authentication, posing a security risk for connected devices and personal data communicated to earbuds. Additionally, traditional earbuds often fail to provide a personalized audio experience tailored to individual users.

According to embodiments, biometric authentication earbuds provide enhanced security and/or personalization in personal audio devices. Biometric authentication earbuds determine and use user-specific (e.g., unique) biometric markers, such as the shape of the ear canal, blood flow in the ear, and/or the ear's auditory response, to authenticate users, enable or adjust earbud operation(s) based on authentication, and/or personalize earbud operation(s) for users. For example, in a usage scenario, a user would insert the earbuds, and the earbud would automatically authenticate the user by analyzing the user's biometric markers compared to one or more authenticated user profiles. Biomarker authentication helps ensure that the earbuds function only for authenticated users, which enhances security for connected devices and data.

In examples, components of biometric authentication earbuds include pressure/force sensors configured to detect the (e.g., unique) pressure patterns caused by the earbud user's ear (e.g., inner ear canal and/or outer ear). For example, there may be an array of pressure/force sensors arranged in layers, rows, columns, etc. Earbud components may (e.g., also) include heartbeat sensors (e.g., photoplethysmography (PPG) sensors) configured to capture the user's heartbeat pattern. Earbud components may (e.g., also) include acoustic sensors (e.g., microphone(s) and speaker(s)) configured to detect the acoustic response of a user's ear to one or more sounds (e.g., inaudible sounds). For example, acoustic sensors can be configured as a sound emitting and recording system configured to create and record the ear's response to impulse sounds for frequency response characterization. Earbud components may (e.g., also) include a microprocessor configured (e.g., with executable instructions) to process and analyze and processes biometric data from the pressure/force sensor(s), PPG sensor(s), and/or acoustic sensor(s), to create user profiles, compare sensed data to user profiles, and make determinations based on the comparisons, such as whether to authorize the user to use the earbuds, whether and what features to enable, what performance settings to adjust, and so on.

In an example, a user wears the earbuds described herein, which (e.g., upon detection of being worn/inserted in ear) triggers the earbud system to start an authentication process.

The earbud detects ear canal pressure patterns on the earbud to develop an additional biomarker. As the earbuds are worn, pressure-sensitive sensors on (e.g., embedded in) one or both earbuds detect the (e.g., unique) pressure patterns exerted by the user's ear canal. Each individual's ear canal shape creates a distinct pressure pattern, which the sensors accurately capture by providing signals captured as discrete samples that form a current/target sample profile for comparison to one or more authorized user profiles.

In some examples, the one or more earbuds perform heartbeat pattern recording. For example (e.g., concurrent with or sequential to pressure pattern sensing), one or more heartbeat sensors (e.g., photoplethysmography (PPG) sensors) embedded in the earbuds capture the user's heartbeat pattern. Detection of a heartbeat pattern involves measuring blood volume changes in the user's ear, which varies with each heartbeat and is generally unique to each individual. Additionally, or alternatively, further derived metrics related to heart rate (e.g., determined from heart rate time series data) include resting heart rate, maximum heart rate, heart rate variability, etc. Any and/or all of these and/or other detected/derived heart rate characteristics may be used in user authentication, as described herein.

In some examples, the one or more earbuds apply sounds and record reflections to develop an additional biomarker. For example (e.g., concurrent with or sequential to pressure pattern sensing), one or more acoustic sensors (e.g., speaker(s)) in one or more earbuds emit sounds. Examples of such emitted input sounds include an impulse signal, a chirp (e.g., linear chirp, geometric chirp, hyperbolic chirp), etc. The sounds are configured to be reflected inside the ear canal. The reflections are captured by a sound recording system (e.g., one or more microphones) in the earbuds. The reflections are used to characterize the frequency response of the user's ear. The earbuds' sound recording system captures the ear's response based on how the ear canal shapes and influences the sound waves, which provides a (e.g., another unique) biometric marker (biomarker). A frequency response of the captured ear response may be analyzed in any suitable manner, including through the use of a Fast Fourier Transform (FFT), or other analysis technique in the frequency domain and/or time domain. The frequency response shows how different frequencies are naturally boosted or attenuated by the user's ear canal shape and characteristics, materializing as peaks (resonances) and troughs (attenuations) in the reflections. chirp

A sensor interface transmits data received from sensors to the microprocessor. The collected data (e.g., pressure patterns alone or with one or more other biomarker data, such as auditory response or heartbeat) is transmitted to a microprocessor in the earbud and/or (e.g., via a transceiver) to a connected host computing device.

Analysis and authentication is performed on the received data. The microprocessor, equipped with profile matching algorithms, analyzes the (e.g., combined) biometric data to authenticate the user. The analysis involves comparing the incoming data with stored profiles to identify and determine whether to authenticate the user.

A determination to authenticate a user may control earbud functionality (e.g., activation of full or partial earbud functions). For example, upon successful authentication, which means the sampled biometric data matches a stored user profile, the earbuds can be configured to become fully functional, which may include access to one or more (e.g., all) features and/or to personalized settings.

Earbud audio experience can be personalized, for example, based on successful authentication. For example (e.g., as part of the authorization activation), the earbuds can be configured to adjust their sound settings according to the user's detected frequency response (e.g., equalization). Personalization can support tailoring earbud audio quality to the user's hearing profile, thereby enhancing user listening experience. Furthermore, upon successful user authentication, device pairing may be performed, such as the earbuds being automatically paired (e.g., via Bluetooth or other communication protocol) with a new device of the authenticated user (e.g., a smart phone, laptop). Still further, upon successful user authentication, voice prompts for the authenticated user may be enabled, such as custom messages the user is enabled to say, etc. In still another example, upon successful user authentication, one or more noise canceling settings may be adjusted for the authenticated user, such as being adjusted to noise canceling settings preset by the user.

Biometric authentication and personalization earbuds provide technical advantages.

The use of pressure patterns as a biometric measure is less complex and more user-friendly than 3D scanning techniques, yet still offers a high level of accuracy for individual identification. Pressure pattern authentication enhances user convenience, for example, by implementing authentication seamlessly when the earbuds are worn without separate user interaction.

The use of multiple types of different biomarkers improves security and the accuracy of performance personalization. The combination of multiple biometric markers (e.g., pressure patterns combined with other biomarkers, such as frequency response and/or heartbeat biomarkers) reduces the possibility of spoofing or replicating another person's unique multi-biometric profile.

A multi-faceted/multi-biomarker approach allows for a personalized audio experience. Earbuds can adjust sound settings based on multiple biomarkers, such as ear shape indicated by multiple biomarkers, providing optimal audio quality (e.g., equalization) tailored to each user's hearing profile.

Biometric authentication earbuds differ technically from other earbuds, for example, by integrating a combination of biometric sensors, such as pressure-sensitive sensors for profiling ear canal shape and an auditory response system for frequency response characterization and/or PPG sensors for heartbeat pattern detection. A multifaceted approach offers a significant advantage over other biometric authentication systems, such as fingerprint or facial recognition often used in personal devices, which can be more vulnerable to spoofing and often require an explicit action (e.g., touching a sensor) for one-time authentication. In contrast, biometric authentication earbuds can provide passive, continuous authentication, which enhances security, authentication speed, and user convenience, since the authentication process is seamless, non-intrusive, and can be configured to be periodic/continuous.

Additionally, a multi-biomarker approach supports integrated personalized audio adjustment to provide a superior listening experience, e.g., without external characterization.

Accordingly, methods, systems, and computer program products are described herein for biometric authentication and personalization earbuds. Biometric authentication earbuds provide enhanced security and/or personalization for personal audio devices, such as a cell phone host device transmitting wireless audio information to the biometric authentication and personalization earbuds. Biometric authentication and personalization earbuds determine and use user-specific (e.g., unique) biometric markers, such as the shape of the inner and outer ear detected by pressure sensors, blood flow in the ear detected by heartbeat sensors (e.g., photoplethysmography (PPG) sensors), and/or the ear's auditory response detected by acoustic sensors, to authenticate users, enable or adjust earbud operation(s) based on authentication, and/or personalize earbud operation(s) for users. For example, upon insertion, earbuds automatically authenticate the user by analyzing the user's biometric markers in comparison to one or more authenticated user biomarker profiles.

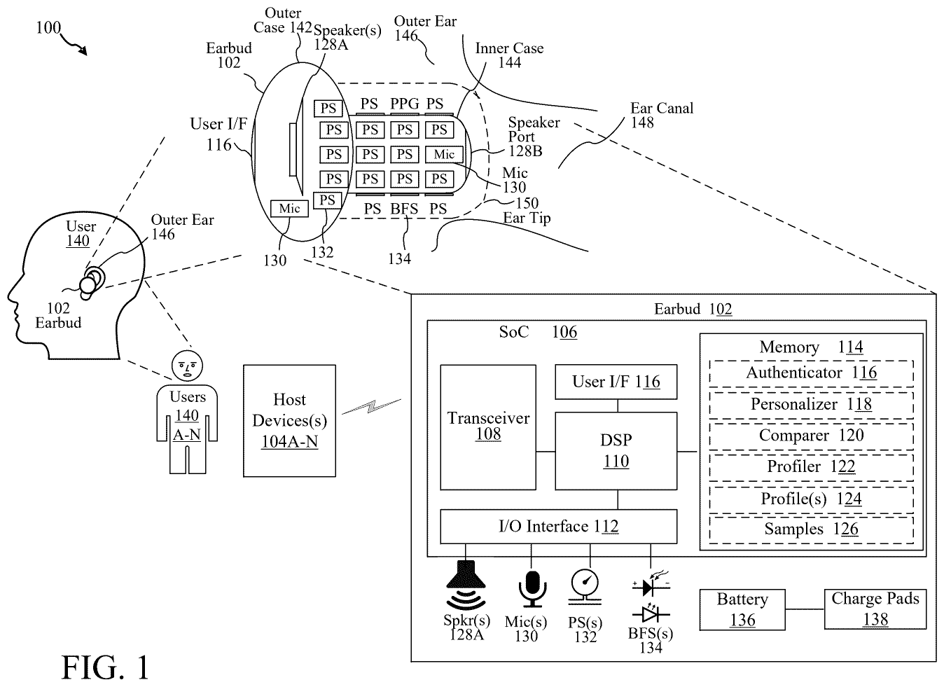

These and further embodiments may be implemented in various ways. To help illustrate such embodiments, and further embodiments, FIGS. 1-8 are described as follows. In particular, FIG. 1 shows an example system 100 that includes a biometric authentication and personalization earbud 102 communicatively coupled/connected to one or more host devices 104A-104N and users who may interact with the earbud and host device(s), according to an embodiment. Note that the terms earbud and earphone may be used interchangeably herein.

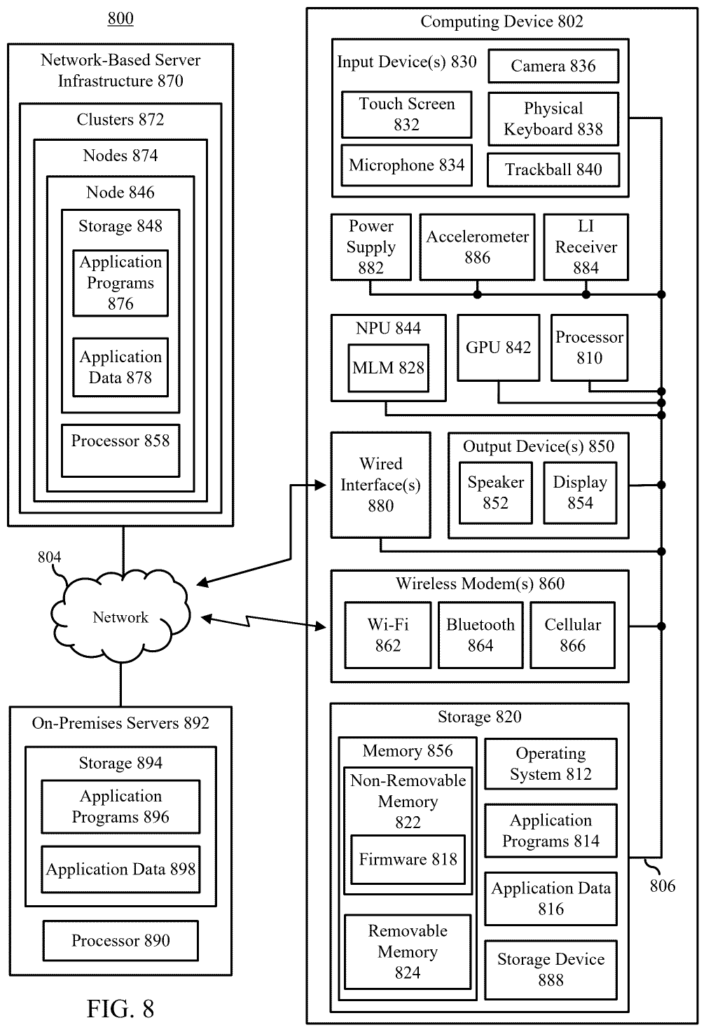

As shown in FIG. 1, example system 100 includes earbud 102 and one or more host devices 104A-104N, which are used/interacted with by user 140. Earbud 102 includes an inner case 144 (having an ear tip 150) and an outer case 142, which together provide a housing for a system on a chip (SoC) 106, one or more speakers 128A, one or more speaker ports 128B, one or more microphones 130, one or more pressure sensors 132, one or more blood flow sensors 134, a battery 136, and one or more charge pads 138. SoC 106 includes a transceiver 108, a digital signal processor (DSP) 110, an input-output (I/O) interface 112, a memory 114, a user interface (I/F) 116. Memory 114 stores an authenticator 116, a personalizer 118, a comparer 120, and a profiler 122. The example shown in FIG. 1 is not intended to show all components in earbud 102 or SoC 106. Various implementations of earbuds may have more, fewer, the same or different components. For instance, in other embodiments, SoC 106 may not be present, and the components of SoC 106 shown in FIG. 1 may be distributed across one or more integrated circuits (ICs), substrates, and/or other electronic devices. Furthermore, one or more of authenticator 116, a personalizer 118, comparer 120, and profiler 122 may be program code structured for execution of a processor (e.g., as shown in FIG. 8), or may be implemented in hardware (e.g., for faster operation) or a combination of hardware and software (including firmware). The features of system 100 are described in further detail as follows.

Earbud 102 may be communicatively coupled/connected (e.g., wirelessly, such as by a Bluetooth® connection) to one or more host devices, e.g., host devices 104A-104N. Note that a pair of earbuds 102 may be present, with each of the pair (e.g., right and left) of earbuds 102 worn in a respective ear of user 140. In such an embodiment, each earbud 102 of the pair operates as described herein for earbud 102, thereby providing twice the accuracy in user authentication due to each earbud 102 of the pair performing its respective authentication functions, which are combined to perform a collective authentication.

One or more of user 140, e.g., users 140A-104N, may interact with earbud 102 and one or more hosts 104A-104N. In various implementations, earbud 102 may be paired with one or many devices, e.g., host devices 104A-104N. In various implementations, earbud 102 may be inserted in the ears of many users, e.g., users 140A-140N. Given the portability and reusability of earbud 102, coupled with the possibility of loss, theft, unauthorized use, and eavesdropping, e.g., by one or more of many possible users 140A-140N, a user 140 of earbud 102 may desire to implement security, such as authorization to use earbud 102 based on a biomarker profile of user 140. User 140 may selectively use one or more biomarker profiles to implement secure use and/or personalized operation. For example, user 140 may interact with earbud 102 alone or in combination with host device 104 to develop a biomarker profile and selectively use the biomarker profile for secure use/authorization and/or for personalized operation of earbuds 102.

Each of host devices 104A-104N may comprise any type of computing device. Each of host devices 104A-104N may be, for example, any type of stationary or mobile, wired or wireless, computing device, such as a mobile computer or mobile computing device (e.g., a personal digital assistant (PDA), a laptop computer, a notebook computer, a tablet computer a netbook, etc.), a mobile phone (e.g., “smart phone”), a wearable computing device, or other type of mobile device, or a stationary computing device such as a desktop computer or PC (personal computer), or a server. Host devices 104A-104N may each comprise one or more applications, operating systems, virtual machines, storage devices, etc. that may be executed, hosted, and/or stored therein or via one or more other (e.g., networked) computing devices. In an example, each of host devices 104A-104N may access one or more server computing devices (e.g., over a network). An example suitable computing device with example features is presented in FIG. 8 and described in detail below. Host devices 104A-104N may each execute one or more applications that may generate an audio signal to be output as sound waveforms by speaker(s) 116, such as a music playback application, a streaming service application, an audio phone call application, an audio/video phone call application, social media applications, a communication pairing application to pair with earbud 102, a communication application to communicate with earbud 102. One or more applications executed by host devices 104A-104N may rely on one or more user profiles 124 stored by earbud 102 (e.g., generated by profiler 122), etc.

Each of host devices 104A-104N may communicate with one or more networks. A network (not shown) may include, for example, any of a local area network (LAN), a wide area network (WAN), a personal area network (PAN), a combination of communication networks, such as the Internet, and/or a virtual network. In example implementations, host devices 104A-104N may be communicatively coupled via one or more networks to one or more private or public resources (e.g., servers). Resources, such as servers and host devices 104A-104N may each include at least one network interface that enables communications over one or more networks. Examples of a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described below. Server(s) (not shown) may comprise one or more servers, such as one or more application servers, database servers, authentication servers, etc. Server(s) may support interaction with host devices 104A-104N. Server(s) may serve data (e.g., streaming music, movies, social media, network-based audio/video call data, etc.) and/or programs to host devices 104A-104N, which provides audio content to earbud 102 for presentation to user 102.

Inner case 144 and outer case 142 of earbud 102 may have any relative shapes and sizes, as desired for a particular implementation. Inner case 144 is configured to be inserted, at least partially, into an ear canal 148 of user 140. One or more sensors can be mounted to, be embedded in, or protrude through inner case 144. Inner case 144 may house, for example, speaker port(s) 128B, microphone(s) 130, pressure sensor(s) 132, blood flow sensor(s) 134, etc. Outer case 142 is configured to remain outside a user's ear canal 148. One or more sensors can be mounted to, be embedded in, or protrude through outer case 142. Outer case 142 may house, for example, speaker(s) 128A, microphone(s) 130, user interface 116, SoC 106, battery 136, charge pads 138, pressure sensor(s) 132, blood flow sensor(s) 134, etc. By placing one or more of these features in/on outer case 142, such features may be user-accessible (e.g., user interface 116 for user touch, microphone(s) 130 for user voice), larger than if confined to inner case 144 (e.g., battery 136), and/or in contact with outer ear features.

Pressure sensors 132 can be mounted to, be embedded in, or protrude through inner case 144 and/or outer case 142. Pressure sensors 132 can be configured, for example, in a pattern, such as an array, rows, columns, which may selected be according to a location relative to features of a user's inner or outer ear. Pressure sensor(s) 132 may be used to detect pressure pattern signals to develop in-ear samples for a pressure pattern profile for user 140, develop samples to compare to the pressure pattern profile for user 140, develop a personalized earbud settings for user 140, etc.

Blood flow sensor(s) (e.g., heartbeat sensor(s)) 134 can be mounted to, be embedded in, or protrude through inner case 144 and/or outer case 142. Blood flow sensor(s) 134 may include, for example, one or more photoplethysmography (PPG) sensors, including light emitting and light detecting sensors. One or more of blood flow sensors 134 may be configured to generate blood volume samples when the earbud 102 is inserted at least partially in the ear canal of user 140. For example, light emitter and light sensor components of a PPG-type blood flow sensor for blood flow sensor(s) 134 generate signals that are used to measure blood volume variation in the ear canal. A light emitter emits light onto a user's ear tissue while a light sensor detects/measures light reflected and/or light passing through a user's ear tissue. The measurements indicate a cyclic nature of the user's blood flow based on the user's heartbeat, such as may be indicated by systolic and diastolic peaks in each cycle. A blood flow sensor may be configured to measure blood volume variation in the ear canal also based on blood pressure variation. Blood pressure is the pressure of blood within the arterial system of the body (e.g., measured in millimeters (mm) of mercury). Blood pressure varies due to a variation between systolic and diastolic measurements, where systolic pressure is the maximum blood pressure during a contraction of the ventricles and diastolic pressure is the minimum pressure during a contraction. A user's blood flow-related measurements, such as blood pressure, heart rate, blood oxygen concentration, etc. may also vary, but the blood flow-related measurements tend to be relatively consistent, detectable, and relatively unique to help distinguish users. A user's blood-related profile (e.g., variation in blood flow indicated by heartbeat, blood pressure, blood oxygen, etc.) may be determined from an analysis of the measurements indicated by PPG sensor signals. The measurements can be used to create a blood flow/heartbeat/blood pressure profile indicative of blood flow dynamics (detectable changes in blood flow) for a current user with the earbud 102 inserted in ear to compare to a blood flow/heartbeat/blood pressure profile for an authorized user. Blood flow sensor(s) 134 may be used to detect blood flow signals to develop in-ear samples for a blood flow profile for an authorized user 140, develop samples of a current user 140 to compare to the blood flow profile for the authorized user 140, develop a personalized earbud settings for authorized user 140, etc.

User interface 116 may provide a user interface for user 140 to interact with earbud 102. For example, user interface 116 may have multiple functions a user may select by a one or more (e.g., a combination of) taps, holds and/or finger presses of user interface 116.

Ear tip 150 is part of or fitted to inner case 144 and/or outer case 142. Ear tip 150 is configured or configurable to adapt to the ears of users 140A-140N. For example, ear tip 150 may be fixed or variable (e.g., removable/replaceable), for example, to fit a variety of sizes and shapes of ear canal 148. Ear tip 150 may be compressible and/or deformable, such as porous foam or an elastomer (e.g., Silicone) to adapt to a variety of ear canal 148 shapes. Ear tip 150 may have a slip/compression fit to inner case 144, for example. Ear tip 150 may compress and/or deform to varying degrees in a variety of ear shapes. Ear tip 150 may impart a pressure or force to each pressure sensor 132 when ear bud 102 is fitted into the ear of user 140.

An example acoustic sensor includes one or more speakers, e.g., speaker(s) 128A, and one or more microphones, e.g., microphone(s) 130.

Speaker(s) 128A emit(s) sound waves based on audio signals (e.g., encoded and decoded by an audio coder/decoder (CODEC) of audio I/O interface 212), such as music, movie audio, phone call audio, acoustical test signals (e.g., inaudible chirps) to generate echoes and in-ear samples to develop an acoustical profile for user 140, etc. One or more (e.g., all) audio signals may be generated by earbud 102 and/or host devices 104A-104N. Sound waves generated by speaker 128A may propagate through speaker port 128B into ear canal 148.

Charge pads 138 may mate with charge pins in an earbud case (not shown) to charge an earbud battery 136 in earbud 102 through a battery in the earbud case and/or a charger attached to the earbud case.

Microphone(s) 130 is representative of one or more microphones in earbud 102. For example, earbud 102 may have one or more feed forward (FF) microphones (e.g., used for audio features), which may be used, for example, to detect the voice of user 140 and/or other sounds external to user 140. Microphone(s) 130 include one or more feedback (FB) microphones (e.g., used for active noise cancellation), which may be used to detect echoes for acoustical test signals (e.g., inaudible chirps) to develop in-ear samples for an acoustical profile for user 140, develop samples to compare to the acoustical profile for user 140, develop a personalized earbud settings for user 140, etc.

Transceiver 108 transmits and receives communications with host devices 104A-104N. Transceiver 108 may be part of a communication manager (not shown), which controls one or more communication links/channels between earbud 102 and host devices 104A-104N. Transceiver 108 includes, for example, transmitter/receiver circuitry, which may include one or more wireless communication antennas, impedance matching circuitry, etc. Transceiver 108 may be configured to support one or more communications, such as Bluetooth®, near field communication (NFC), etc. For example, an earbud case (not shown) may communicate power and/or data to earbud 102 (e.g., and earbud 102 may communicate data to an earbud case) using NFC (e.g., in which case charge pins 110 and charge pads 138 may be unnecessary. For example, host devices 104A-104N and earbud 102 may communicate using a Bluetooth® connection/link/channel.

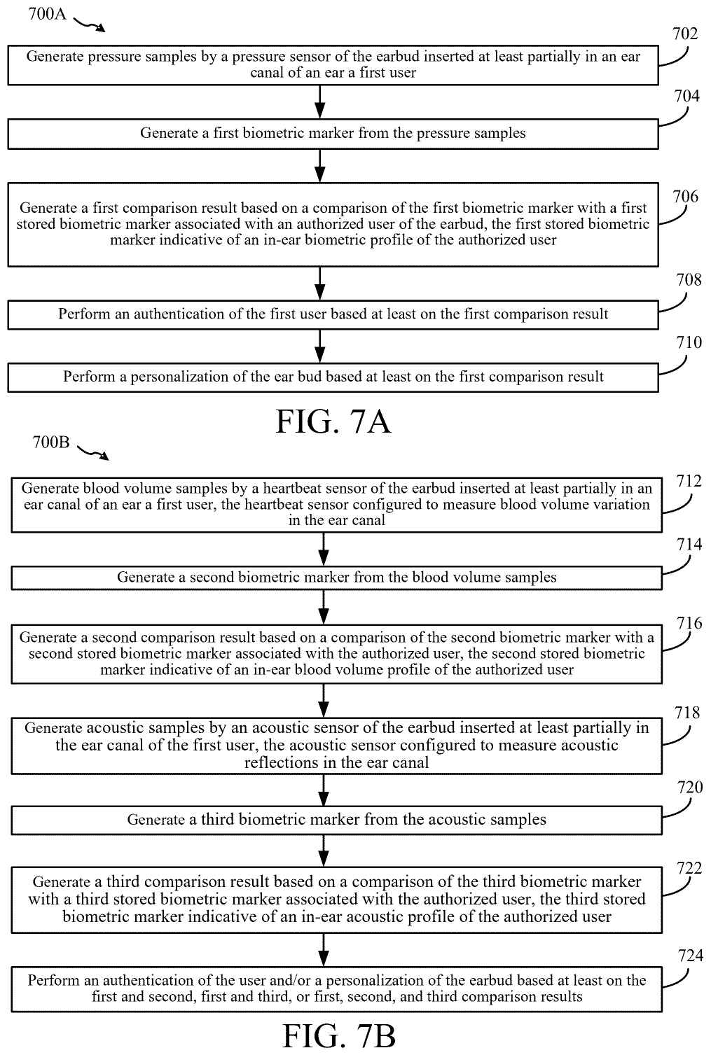

Digital signal processor (DSP) 110 executes program code stored in memory 114, such as program code for profiler 122, comparer 120, personalizer 118, and authenticator 116. Memory 114 does not show all program code executed by DSP 110. DSP 110 may process data to/from transceiver 108, user I/F 116, I/O interface 112, etc., for example, in accordance with executable code from one or more programs in memory 114. Examples of processing (e.g., of executable program instructions) performed by DSP 110 is shown in FIGS. 7A and 7B.

I/O interface 112 provides an interface to at least one speaker (Spkr(s)) 128A, at least one microphone (mic(s)) 130 (e.g., feedback (FB) microphone(s) and/or feed forward (FF) microphones), at least one pressure sensor (PS) 132, and at least one blood flow sensor (BFS) (e.g., heart rate sensor), such as a PPG sensor(s). I/O interface 112 may include analog to digital converters that sample signals. For example, I/O interface 112 may generate and store samples 126 from sensor signals received from spkr(s) 128A, mic(s) 130, PS(s) 132, and/or PPG(s) 134.

I/O interface 112 may include an audio encoder decoder (CODEC). For example, I/O interface 112 may provide audio coding and decoding for audio signals received from DSP 110, spkr (2) 128A, mic(s) 130, etc. An encoder may encode a signal/data stream (e.g., echo signal generated an FB Mic 130) for storage in memory 114 (e.g., as a file, such as an in-car or out-of-car sample) or transmission. A decoder may decode a signal/data stream (e.g., received from transceiver 108 or a file accessed from storage (e.g., memory 114). I/O interface 112 may generate and (e.g., with assistance of DSP 110) store samples 126 from sensor signals received from spkr(s) 128A, mic(s) 130, PS(s) 132, and/or PPG(s) 134.

User interface (I/F) 116 may sense and process interaction by user 140 with user interface 116. User I/F 116 may generate executable instructions (e.g., flags or interrupts) for handling by DSP 110. For example, a detected user interaction may cause touch I/F 116 to instruct DSP 110 to change a state of operation of earbud 102 in a state machine, such as from playback of audio provided by host device 104 to stop playback or vice versa.

Spkr(s) 128A emit sound waves based on audio signals (e.g., encoded and decoded by a CODEC of I/O interface 112), such as music, movie audio, phone call audio, acoustical test signals (e.g., inaudible chirps) to generate echoes and in-car samples to develop an acoustical profile for user 140, etc. For example, profiler 122 may include sample generator code executed by DSP 110 that provides to I/O interface 112 for output by spkr(s) 128A signals alone and/or in combination with an audio data stream from host 204 to generate reflections/echos detected by mic(s) 130, leading to samples 126 used by profiler 122 to create authorized user profiles 124 and current user profiles 124 for comparer 120 to compare against authorized user profiles 124.

FB mic(s) 130 may detect echoes for acoustical test signals (e.g., inaudible chirps) to develop in-car samples 126 for an acoustical profile 124 for (e.g., authorized/current) user 140, etc. I/O interface 112 may sample and code the signal(s) generated by FB mic 130 for processing by profiler 122. For example, profiler 122 may include a sample generator program used by DSP 110 to generate samples 126.

FF mic(s) 130 may detect the voice of user 140 and/or other sounds external to user 140. I/O interface 112 may sample and code the signal(s) generated by FF mic(s) 130 for processing by profiler 122.

PS(s) 132 may detect pressure pattern signals to develop in-car samples 126 for a pressure pattern profile 124 for an authorized user 140, develop samples 126 for a current user profile 124 for a current user 140 to compare to the authorized user pressure pattern profile 124, develop a personalized earbud settings for authorized user 140, etc.

BFS(s) 134 may be used to detect blood flow signals to develop in-car samples 126 for a blood flow profile 124 for an authorized user 140, develop samples 126 for a current user profile 124 to compare to the authorized user blood flow profile 126, develop a personalized earbud settings for an authorized user 140, etc.

Memory 114 stores programs (e.g., executable program code, such as for authenticator 116, personalizer 118, comparer 120, profiler 122, and data (e.g., authorized and current user profiles 124 for acoustic profiles, pressure pattern profiles, and/or blood flow profiles, acoustic, pressure pattern, and/or blood flow samples for authorized and current users 104). Memory 114 may include one or more types of volatile and/or non-volatile memory (e.g., RAM (random access memory), ROM (read only memory), EEPROM (electrically erasable programmable ROM), flash memory) with or without one or more layers of cache memory. In some examples, memory 114 may include (e.g., only) non-volatile memory. In some examples, memory 114 may include volatile memory (e.g., RAM) and non-volatile memory (e.g., ROM), in which case programs may be loaded from ROM to RAM for execution by DSP 110.

In an embodiment, profiler 122 is an executable program, executed by DSP 110, that provides authenticated/current user profile generation functionality for earbud 102. Profiler 122 may have one or more routines, subroutines, etc. that implement logic in the service of user profiling functionality. For example, profiler 122 may have a sample generator routine for authorized/current users 104 that (e.g., when executed by DSP 110) accesses in memory or generates audio signals and provides them to I/O interface 112 for output as audio waveforms through spkr(s) 128A directly or indirectly (e.g., by mixing with other audio signals). The sample generator routine executed by DSP 110 may expect to receive through I/O interface 112 an echo data stream generated by FB mic(s) 130 based on detection of echo signals, which I/O interface 112 may sample, amplify, filter, and convert from analog to digital data that DSP 110 stores as acoustic response samples 126. Profiler 122 also has a profile generator routine that generates profiles 124 for authorized users and current users based on samples 126. Profiler 122 may distinguish between an authorized user and a current user of earbud 102. Profiler 122 may be configured to generate one or more types of profiles based on one or more types of biomarker samples, e.g., pressure pattern samples, acoustic response samples, and/or blood flow samples. For example, profiler 122 may be configured to generate separate biomarker profiles or combined biomarker profiles for each user (e.g., an authorized user and a current user). For example, a single user profile may be based on multiple biomarker samples (e.g., pressure pattern samples and acoustic samples, pressure pattern samples and blood flow samples, pressure pattern samples, acoustic samples, and blood flow samples). Profiler 122 may generate profiles for a current user one-time, periodically, or aperiodically.

In an embodiment, comparer 120 is an executable program, executed by DSP 110, that provides comparison of authenticated and user profiles functionality for earbud 102. Comparer 120 accesses profiles 124 from memory 114. Comparer 120 compares a biomarker profile for a current user to a biomarker profile for an authorized user. Comparer 120 may have routines and subroutines configured to make separate or combined comparisons of different biomarkers in each current/authorized user profile. For example, comparer 120 may compare the pressure sensor values in respective rows/columns/layers of pressure sensor samples in current and authorized user profiles. Comparer 120 may be configured to store the comparison results in memory 114, e.g., as one or more parameters for each biomarker involved in a comparison. Comparison results may include values indicating the difference/similarity of the compared profiles with respect to one or more parameters considered by authenticator 116. For example, comparison results may indicate the difference in sensed pressure values for each pressure sensor, the difference in acoustic response values for each acoustic signal, and/or the difference in blood flow samples. Comparer 120 may perform one-time, periodic, or aperiodic comparisons.

In an embodiment, authenticator 116 is an executable program, executed by DSP 110, that provides user authentication functionality for earbud 102. Authenticator 116 accesses comparison results stored in memory 114. Authenticator 116 analyzes comparison results (e.g., parameter values), for example, based on one or more thresholds that indicate sufficient similarity between current and authorized user profiles. Authenticator 116 makes a determination whether a current user is an authorized user based on the analysis of comparison results. Authenticator 116 may be configured to enable one or more functions of earbud 102 based on successful authentication of a current user 140. For example, authenticator 116 may be configured to allow a current user authenticated as an authorized user to play audio from a phone call on host device 104 and/or music provided by host device 104. Authenticator 116 may deny one or more (e.g., all) operations/uses of earbud 102 if a current user is not authorized. Authenticator 116 may communicate the authentication determination to host device 104, which may inform user 104 of the authentication determination. Authenticator 116 may store the current authentication determination in memory 114. Authenticator 116 may perform one-time, periodic, or aperiodic (e.g., event driven) authentications of a current user. For example, an event may be a detected removal of earbud 102 and/or passage of time before a detected insertion of earbud 102.

In an embodiment, personalizer 118 is an executable program, executed by DSP 110, that provides earbud personalization functionality for earbud 102. Personalizer 118 may access the current authentication determination in memory 114 to determine whether to access user profile(s) 124 in memory 114. Personalizer 118 may use user profile 124 to personalize one or more features/operations of earbud 102 for authorized user 140. For example, personalizer 118 may adjust one or more audio settings of earbud 102 based on one or more biomarker profiles indicated in user profile 124, such as the fit of earbud 102 in user's ear indicated by pressure sensor values for each PS 132, the acoustic response values by user's ear for each acoustic signal emitted by spkr(s) 128A, and so on.

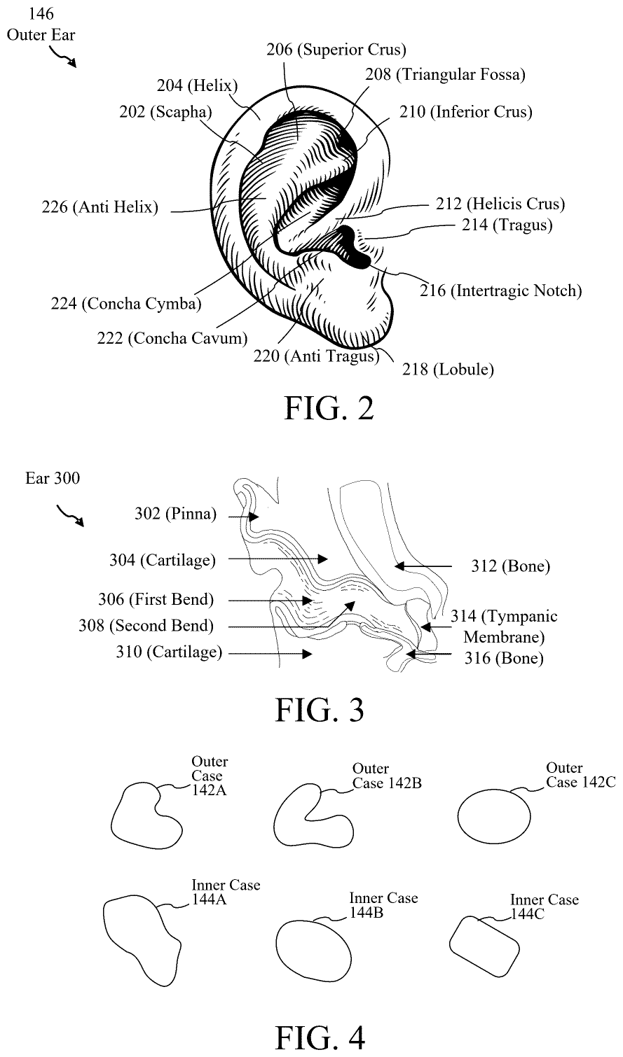

As described above, earbud 102 may be inserted into an ear of a user 140, such that inner case 144 at least partial extends into the ear canal 148 of user 140, and outer case 142 resides outside of ear canal 148 in and/or adjacent to outer ear 146 of user 140. For reference, FIG. 2 shows an example of an outer ear 146 shown in FIG. 1. For reference, FIG. 2 shows the anatomical names of the anatomy of outer ear 146, including the scapha 202, the helix 204, the superior crus 206, the triangular fossa 208, the inferior crus 210, the helicis crus 212, the tragus 214, the intertragic notch 216, the lobule 218, the anti tragus 220, the concha cavum 222, the concha cymba 224, and the anti helix 226.

Furthermore, for reference, FIG. 3 shows an example of a cross-section of an ear 300. Ear 300 of FIG. 3 includes portions of outer ear 146, a middle ear, an inner ear, and surrounding anatomy, including the pinna 302 (outer ear), cartilage 304 (outer ear) adjacent the pinna 302, the first bend 306 (middle ear) of ear canal 148, the second bend 308 (middle car) of the ear canal 148, cartilage 310 (outer ear) below the second bend, the tympanic membrane 314, the bone 316 below the tympanic membrane (car drum; middle ear), and the bone 312 (middle ear) above the tympanic membrane.

According to embodiments, earbud 102 may be shaped to conform to the ears of users. For instance, FIG. 4 shows examples of shapes of outer case 142 and inner case 144 of FIG. 1 that may be populated with one or more types of authentication and personalization sensors to detect user-specific ear features, according to an embodiment. A variety of combinations of inner and outer case shapes may be combined to form a case for earbud 102. Inner and outer ear case shapes may be, for example, circular, non-circular, symmetrical, non-symmetrical, anatomical, non-anatomical, and so on. Shapes may be selected to acquire more anatomical information, such as 3D geometric/spatial variation information to better capture the uniqueness of each user's ears. For example, FIG. 4 shows first-third outer cases 142A-142C and first-third inner cases 144A-144C, which are described in further detail as follows.

With reference to FIG. 2, outer case 142A of FIG. 4 may have a heart-shape that extends to more deeply contact the concha cymba 224 and concha cavum 222, forming (e.g., receding) around the helicis crus 212 for better conformity and adherence to outer ear 146. Outer case 142B of FIG. 4 may have a more pronounced heart-shape that extends to more deeply contact the concha cymba 224 and concha cavum 222, forming (e.g., receding) further around the helicis crus 212 than outer case 142A for even better conformity and adherence. Outer case 142C of FIG. 4 (e.g., similar to outer case 142 shown in FIG. 1) may have a circular and/or oval shape that, depending on dimensions, contacts the concha cymba 224, concha cavum 222, helicis crus 212, tragus 214, intertragic notch 216, anti tragus 220, and/or anti helix 226 for still better conformity and adherence. Other shapes of outer case 142 may be implemented.

The shape of outer case 142 (FIG. 1) may be selected, for example, based on the three dimensional geometry that one desires to glean from a user's outer ear, for example, using an array of sensors (e.g., pressure sensors) populating the ear-facing (e.g., inner) side of outer case 142. The shape of outer case 142 may also be selected, for example, based on fit to a variety of user's ears.

As shown with reference to FIG. 2, inner case 144A of FIG. 4 may have a shape that conforms (e.g., curves, narrows, broadens) to first bend 306 and/or second bend 308 of the ear canal 148 for reasons of comfort and to be secured more snugly in ear canal 148. Inner case 144B of FIG. 4 has an oval shape configured to secure snugly in ear canal 148. Inner case 144C may have a cylindrical shape to conform to a variety of ear canals 148 more generically. Other shapes of inner case 144 may be implemented.

The shape of inner case 144 may be selected, for example, based on the three dimensional geometry that one desires to glean from a user's middle and/or inner ear, for example, using an array of sensors (e.g., pressure sensors) populating inner case 144. The shape of inner case 144 may also be selected, for example, based on fit to a variety of user's cars.

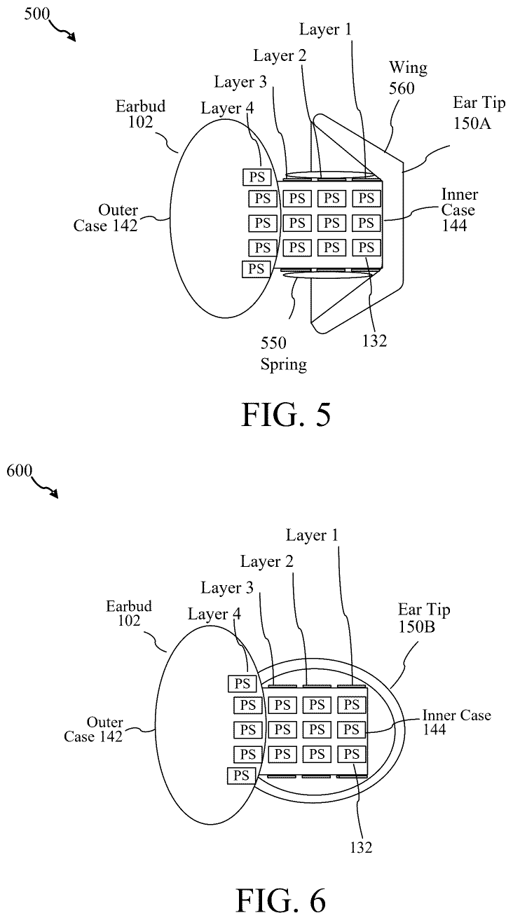

FIG. 5 shows an example system 500 that includes a biometric authentication and personalization earbud 102 with an ear tip 150A configured to apply pressure to sensors based on ear shape, according to an example embodiment. In particular, system 500 includes earbud 102, with outer case 142 and inner case 144, a spring 550, and a wing 560 that forms an ear tip 150A. FIG. 5 shows earbud 102 in a cross-sectional view of deformable/compressible ear tip 150A and a spring 550. System 500 is described in further detail as follows.

Spring 550 may be, for example, a leaf spring (e.g., made of metal, plastic, etc.). Spring 550 may include one or more discrete springs or a continuous spring surrounding inner case 144 and or the inner side of outer case 142. In some examples, ear tip 150A may be implemented without spring 550 or with a different spring.

Ear tip 150A may include a wing 560 forming a cup/bowl configured to deform upon insertion into a user's ear canal. Wing 560 may be long enough to press against PSs 132 on outer case 142 when fully compressed. Wing 560 may be segmented or continuous around inner case 144. Ear tip material may be, for example, an elastomer, such as Silicone, or other deformable/compressible material to form fit in a user's ear canal. Insertion of ear tip 150A and inner case 144 into a user's ear canal may cause the wing portion of ear tip 150A to fold inward. Thus, as the wing 560 deforms, wing 560 compresses the spring 550 against PSs 132. The varying pressure applied to each PS 132 indicates a user's unique ear geometry. Ear tip 150A may be considered a compression fitting, and in some embodiments, is configured to transfer contact pressure from the concha cymba to one or more PSs 132.

Pressure sensors (PSs) 132 are shown as an array of pressure sensors having layers, rows, and/or columns, such as layer 1 that may be inserted the furthest into a user's ear canal, layer 2, layer 3, and layer 4 that may be the least insertable into a user's ear canal. PSs generate signals as spring 550 is compressed due to compression of wing 560. Profiler 122 may determine one dimensional pressure patterns (e.g., X or Y direction) or multiple dimensional pressure patterns (e.g., X and Y directions) based on signals generated by PSs. Comparer 120 may compare the one or multiple dimensional pressure patterns of a current user to an authorized user. Comparer 120 may consider potential skews in patterns, e.g., due to insertion variation and/or movement. Comparer 120 may perform one-time, periodic, or aperiodic comparisons. Authenticator 116 may determine whether the one or multiple dimensional pressure patterns are similar enough based on potential skews in the patterns due to insertion variation and movement.

FIG. 6 shows a system 600 that is an example of a biometric authentication and personalization earbud with an ear tip configured to apply pressure to sensors based on ear shape, according to an example embodiment. FIG. 6 shows system 600 with earbud 102 in a cutaway or cross-section view of deformable/compressible ear tip 150B.

Ear tip 150B may be configured with a bulbous shape with material or air between car tip 150B and inner case 144. Ear tip 150B is configured to deform upon insertion into a user's ear canal. Ear tip 150B may be large enough, bend upwards on outer case 142, and/or deformable enough to press against PSs on outer case 142 when fully compressed. Ear tip material may be, for example, an elastomer, such as Silicone, a porous foam, or other deformable/compressible material to form fit in a user's ear canal. Insertion of ear tip 150B and inner case 144 into a user's ear canal may cause ear tip 150B to compress towards and onto PSs 132. The varying pressure applied to each PS 132 indicates a user's unique ear geometry. Ear tip 150B may be considered a compression fitting, and in some embodiments, is configured to transfer contact pressure from the concha cymba to one or more PSs 132. By increasing contact pressure from the concha cymba to one or more PSs 132, PSs 132 may gain a better reading on the particular shape of the concha cymba of the user, which increases the accuracy of user authentication.

Pressure sensors (PSs) 132 are shown as an array of pressure sensors having layers, rows, and/or columns, such as layer 1 that may be inserted the furthest into a user's ear canal, layer 2, layer 3, and layer 4 that may be the least insertable into a user's ear canal. PSs 132 generate signals as ear tip 150B is compressed onto PSs 132. Profiler 122 may determine one dimensional pressure patterns (e.g., X or Y direction) or multiple dimensional pressure patterns (e.g., X and Y directions) based on signals generated by PSs. Comparer 120 may compare the one or multiple dimensional pressure patterns of a current user to an authorized user. Comparer 120 may consider potential skews in patterns, e.g., due to insertion variation and/or movement. Comparer 120 may perform one-time, periodic, or aperiodic comparisons. Authenticator 116 may determine whether the one or multiple dimensional pressure patterns are similar enough based on potential skews in the patterns due to insertion variation and movement.

Examples shown and discussed with respect to FIGS. 1-6 may operate, for example, according to example methods presented in FIGS. 7A and/or 7B. FIGS. 7A and 7B show flowcharts 700A and 700B of example methods of operation of a biometric authentication and personalization earbud, according to an example embodiment.

Embodiments disclosed herein and other embodiments may operate in accordance with example flowchart 700A. Flowchart 700A comprises steps 702-710, one or more of which are indicated as optional by dashed lines. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 7A. FIG. 7A is simply one of many possible embodiments. Embodiments may implement fewer, more, or different steps.

As shown in FIG. 7A, flowchart 700A includes step 702. In step 702, pressure samples are generated by a pressure sensor of the earbud inserted at least partially in an ear canal of an ear a first user. For example, as shown in FIG. 1, PSs 132 generate pressure signals with earbud 102 in the ear canal of current user 140, which I/O interface 112 samples and stores as pressure samples 126 in memory 114.

In step 704, a first biometric marker is generated from the pressure samples. For example, as shown in FIG. 1, profiler 122 accesses and uses samples 126 to create a pressure biomarker profile 124 for current user 140.

In step 706, a first comparison result is generated based on a comparison of the first biometric marker with a first stored biometric marker associated with an authorized user of the earbud, the first stored biometric marker indicative of an in-ear biometric profile of the authorized user. For example, as shown in FIG. 1, comparer 120 compares the pressure biomarker profile of the current user generated by profiler 122 to a stored pressure biomarker profile 124 of at least one authorized user of earbud 102. Comparer 120 generates a comparison result, which is provided or otherwise made available to authenticator 116.

In step 708, an authentication of the first user is performed based at least on the first comparison result. For example, as shown in FIG. 1, authenticator 116 determines whether the values in the comparison result are within allowable differences to determine whether the current user is deemed an authorized user or an unauthorized user.

In step 710, a personalization of the ear bud is performed based at least on the first comparison result. For example, as shown in FIG. 1, personalizer 118 may, e.g., if the current user is authorized by authenticator 116, personalize one or more features of earbud 102 based on the comparison result.

Embodiments disclosed herein and other embodiments may operate in accordance with example flowchart 700B. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 7B. FIG. 7B is simply one of many possible embodiments. Embodiments may implement fewer, more, or different steps.

As shown in FIG. 7B, flowchart 700B includes step 712. In step 712, blood volume samples are generated from signals generated by a heartbeat sensor of the earbud inserted at least partially in an ear canal of an ear a first user, the heartbeat sensor configured to measure blood volume variation in the ear canal. For example, as shown in FIG. 1, PPG sensor(s) 134 is an example type of heartbeat sensor that generates blood flow signals with earbud 102 in the ear canal of current user 140, which I/O interface 112 samples and stores as blood flow samples 126 in memory 114.

In step 714, a second biometric marker is generated from the blood volume samples. For example, as shown in FIG. 1, profiler 122 accesses and uses blood flow samples 126 to create a blood flow biomarker profile 124 for current user 140. Blood volume changes in a user's ear varies with each heartbeat and is generally unique to each individual, and thus generating of the second biometric marker enables greater accuracy in user authentication.

In step 716, a second comparison result is generated based on a comparison of the second biometric marker with a second stored biometric marker associated with the authorized user, the second stored biometric marker indicative of an in-ear blood volume profile of the authorized user. For example, as shown in FIG. 1, comparer 120 compares the blood flow biomarker profile of the current user generated by profiler 122 to a stored blood flow biomarker profile 124 of at least one authorized user of earbud 102. Comparer 120 generates a comparison result, which is provided or otherwise made available to authenticator 116.

In step 718, acoustic samples are generated from signals generated by an acoustic sensor of the earbud inserted at least partially in the ear canal of the first user, the acoustic sensor configured to measure acoustic reflections in the ear canal. For example, as shown in FIG. 1, with earbud 102 in the ear canal of current user 140, speaker(s) 128A emit inaudible sound waves and mic(s) 130 generate acoustic signals from sound wave reflections, which I/O interface 112 samples and stores as acoustic samples 126 in memory 114. Acoustic samples 126 are usable to develop a unique acoustical profile for user 140, which enables identification of user 140 with increased accuracy.

In step 720, a third biometric marker is generated from the acoustic samples. For example, as shown in FIG. 1, profiler 122 accesses and uses acoustic samples 126 to create an acoustic biomarker profile 124 for current user 140.

In step 722, a third comparison result is generated based on a comparison of the third biometric marker with a third stored biometric marker associated with the authorized user, the third stored biometric marker indicative of an in-ear acoustic profile of the authorized user. For example, as shown in FIG. 1, comparer 120 compares the acoustic biomarker profile of the current user generated by profiler 122 to a stored acoustic biomarker profile 124 of at least one authorized user of earbud 102. Comparer 120 generates a comparison result, which is provided or otherwise made available to authenticator 116.

In step 724, an authentication of the user and/or a personalization of the earbud is performed based at least on the first and second, first and third, or first, second, and third comparison results. For example, as shown in FIG. 1, authenticator 116 determines whether the values in the comparison results for the pressure biomarker comparison and one or both the blood flow biomarker comparison or the acoustic biomarker comparison are within allowable differences to determine whether the current user is deemed an authorized user or an unauthorized user. By using multiple comparison results that corroborate each other, greater accuracy in user authentication is attained.

### III. Example Computing Device Embodiments

Earbud 102, host device 104, SoC 106, transceiver 108, DSP 110, I/O interface 112, memory 114, authenticator 116, personalizer 118, comparer 120, profiler 122, and flowcharts 700A and 700B, are implemented in hardware, or hardware combined with one or both of software and/or firmware. For example, earbud 102, host device 104, SoC 106, transceiver 108, DSP 110, I/O interface 112, memory 114, authenticator 116, personalizer 118, comparer 120, profiler 122, and flowcharts 700A and 700B are each implemented as computer program code/instructions configured to be executed in one or more processors and stored in a computer readable storage medium. Alternatively, earbud 102, host device 104, SoC 106, transceiver 108, DSP 110, I/O interface 112, memory 114, authenticator 116, personalizer 118, comparer 120, profiler 122, and flowcharts 700A and 700B are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 8. FIG. 8 shows a block diagram of an exemplary computing environment 800 that includes a computing device 802. Computing device 802 is an example of each of user device 104, user terminal 106 and server 110, which may each include one or more of the components of computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc. In examples, network 804 includes one or more wired and/or wireless portions. In some examples, network 804 additionally or alternatively includes a cellular network for cellular communications. Computing device 802 is described in detail as follows.

Computing device 802 is any of a variety of types of computing devices. Examples of computing device 802 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 802 is a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, a graphics processing unit (GPU) 842, a neural processing unit (NPU) 844, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 888. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and in a particular embodiment any combination of the components are present. In examples, components of computing device 802 are mounted to a circuit card (e.g., a motherboard) of computing device 802, integrated in a housing of computing device 802, or otherwise included in computing device 802. The components of computing device 802 are described as follows.

In embodiments, a single processor 810 (e.g., central processing unit (CPU), microcontroller, a microprocessor, signal processor, ASIC (application specific integrated circuit), and/or other physical hardware processor circuit) or multiple processors 810 are present in computing device 802 for performing such tasks as program execution, signal coding, data processing, input/output processing, power control, and/or other functions. In examples, processor 810 is a single-core or multi-core processor, and each processor core is single-threaded or multithreaded (to provide multiple threads of execution concurrently). Processor 810 is configured to execute program code stored in a computer readable medium, such as program code of operating system 812 and application programs 814 stored in storage 820. The program code is structured to cause processor 810 to perform operations, including the processes/methods disclosed herein. Operating system 812 controls the allocation and usage of the components of computing device 802 and provides support for one or more application programs 814 (also referred to as “applications” or “apps”). In examples, application programs 814 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 810 includes one or more general processors (e.g., CPUs) configured with or coupled to one or more hardware accelerators, such as one or more NPUs 844 and/or one or more GPUs 842.

Any component in computing device 802 can communicate with any other component according to function, although not all connections are shown for case of illustration. For instance, as shown in FIG. 8, bus 806 is a multiple signal line communication medium (e.g., conductive traces in silicon, metal traces along a motherboard, wires, etc.) present to communicatively couple processor 810 to various other components of computing device 802, although in other embodiments, an alternative bus, further buses, and/or one or more individual signal lines is/are present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 888, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 822 includes main memory and is separate from or fabricated in a same integrated circuit as processor 810. As shown in FIG. 8, non-removable memory 822 stores firmware 818 that is present to provide low-level control of hardware. Examples of firmware 818 include BIOS (Basic Input/Output System, such as on personal computers) and boot firmware (e.g., on smart phones). In examples, removable memory 824 is inserted into a receptacle of or is otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 888 are present that are internal and/or external to a housing of computing device 802 and are or are not removable. Examples of storage device 888 include a hard disk drive, a SSD, a thumb drive (e.g., a USB (Universal Serial Bus) flash drive), or other physical storage device.

One or more programs are stored in storage 820. Such programs include operating system 812, one or more application programs 814, and other program modules and program data. Examples of such application programs include computer program logic (e.g., computer program code/instructions) for implementing earbud 102, host device 104, SoC 106, transceiver 108, DSP 110, I/O interface 112, memory 114, authenticator 116, personalizer 118, comparer 120, profiler 122, and flowcharts 700A and 700B, and/or any individual steps thereof.

Storage 820 also stores data used and/or generated by operating system 812 and application programs 814 as application data 816. Examples of application data 816 include web pages, text, images, tables, sound files, video data, and other data. In examples, application data 816 is sent to and/or received from one or more network servers or other devices via one or more wired or wireless networks. Storage 820 is used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 802 through one or more input devices 830 and receives information from computing device 802 through one or more output devices 850. Input device(s) 830 includes one or more of touch screen 832, microphone 834, camera 836, physical keyboard 838 and/or trackball 840 and output device(s) 850 includes one or more of speaker 852 and display 854. Each of input device(s) 830 and output device(s) 850 are integral to computing device 802 (e.g., built into a housing of computing device 802) or are external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 displays information, as well as operating as touch screen 832 by receiving user commands and/or other information (e.g., by touch, finger gestures, virtual keyboard, etc.) as a user interface. Any number of each type of input device(s) 830 and output device(s) 850 are present, including multiple microphones 834, multiple cameras 836, multiple speakers 852, and/or multiple displays 854.

In embodiments where GPU 842 is present, GPU 842 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 842 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 844 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 828. In an example, NPU 844 is configured for a data-driven parallel computing and is highly efficient at processing massive multimedia data such as videos and images and processing data for neural networks. NPU 844 is configured for efficient handling of AI-related tasks, such as speech recognition, background blurring in video calls, photo or video editing processes like object detection, etc.

In embodiments disclosed herein that implement ML models, NPU 844 can be utilized to execute such ML models, of which MLM 828 is an example. For instance, where applicable, MLM 828 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 844 is used to train MLM 828. To train MLM 828, training data is that includes input features (attributes) and their corresponding output labels/target values (e.g., for supervised learning) is collected. A training algorithm is a computational procedure that is used so that MLM 828 learns from the training data. Examples of training inputs for ML model training include user position, angle, gesture, time of day, location, user crypto, etc. Parameters/weights are internal settings of MLM 828 that are adjusted during training by the training algorithm to reduce a difference between predictions by MLM 828 and actual outcomes (e.g., output labels). In some examples, MLM 828 is set with initial values for the parameters/weights. A loss function measures a dissimilarity between predictions by MLM 828 and the target values, and the parameters/weights of MLM 828 are adjusted to minimize the loss function. The parameters/weights are iteratively adjusted by an optimization technique, such as gradient descent. In this manner, MLM 828 is generated through training by NPU 844 to be used to generate inferences based on received input feature sets for particular applications. MLM 828 is generated as a computer program or other type of algorithm configured to generate an output (e.g., a classification, a prediction/inference) based on received input features and is stored in the form of a file or other data structure.

In examples, such training of MLM 828 by NPU 844 is supervised or unsupervised. According to supervised learning, input objects (e.g., a vector of predictor variables) and a desired output value (e.g., a human-labeled supervisory signal) train MLM 828. The training data is processed, building a function that maps new data on expected output values. Example algorithms usable by NPU 844 to perform supervised training of MLM 828 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 828 is an LLM, MLM 828 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 828 is trained to learn patterns from unlabeled data. For instance, in embodiments where MLM 828 implements unsupervised learning techniques, MLM 828 identifies one or more classifications or clusters to which an input belongs. During a training phase of MLM 828 according to unsupervised learning, MLM 828 tries to mimic the provided training data and uses the error in its mimicked output to correct itself (i.e., correct weights and biases). In further examples, NPU 844 perform unsupervised training of MLM 828 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 844 need not necessarily be present in all ML model embodiments. In embodiments where ML models are present, any one or more of processor 810, GPU 842, and/or NPU 844 can be present to train and/or execute MLM 828.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). In examples, wireless modem 860 also or alternatively includes other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and receives power from a battery internal to computing device 802, and/or from a power cord plugged into a power port of computing device 802 (e.g., a USB port, an A/C power port). LI receiver 884 is useable for location determination of computing device 802 and in examples includes a satellite navigation receiver such as a Global Positioning System (GPS) receiver and/or includes other type of location determiner configured to determine location of computing device 802 based on received information (e.g., using cell tower triangulation, etc.). Accelerometer 886, when present, is configured to determine an orientation of computing device 802.

Note that the illustrated components of computing device 802 are not required or all-inclusive, and fewer or greater numbers of components can be present as would be recognized by one skilled in the art. In examples, computing device 802 includes one or more of a gyroscope, barometer, proximity sensor, ambient light sensor, digital compass, etc. In an example, processor 810 and memory 856 are co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein is stored in storage 820 and executed by processor 810.

In some embodiments, server infrastructure 870 is present in computing environment 800 and is communicatively coupled with computing device 802 via network 804. Server infrastructure 870, when present, is a network-accessible server set (e.g., a cloud-based environment or platform). As shown in FIG. 8, server infrastructure 870 includes clusters 872. Each of clusters 872 comprises a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. In examples, any of nodes 874 is a storage node that comprises a plurality of physical storage disks, SSDs, and/or other physical storage devices that are accessible via network 804 and are configured to store data associated with the applications and services managed by nodes 874.

Each of nodes 874, as a compute node, comprises one or more server computers, server systems, and/or computing devices. For instance, a node 874 in accordance with an embodiment includes one or more of the components of computing device 802 disclosed herein. Each of nodes 874 is configured to execute one or more software applications (or “applications”) and/or services and/or manage hardware resources (e.g., processors, memory, etc.), which are utilized by users (e.g., customers) of the network-accessible server set. In examples, as shown in FIG. 8, nodes 874 includes a node 846 that includes storage 848 and/or one or more of a processor 858 (e.g., similar to processor 810, GPU 842, and/or NPU 844 of computing device 802). Storage 848 stores application programs 876 and application data 878. Processor(s) 858 operate application programs 876 which access and/or generate related application data 878. In an implementation, nodes such as node 846 of nodes 874 operate or comprise one or more virtual machines, with each virtual machine emulating a system architecture (e.g., an operating system), in an isolated manner, upon which applications such as application programs 876 are executed.

In embodiments, one or more of clusters 872 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 872 are included in a datacenter in a distributed collection of datacenters. In embodiments, exemplary computing environment 800 comprises part of a cloud-based platform.

In an embodiment, computing device 802 accesses application programs 876 for execution in any manner, such as by a client application and/or a browser at computing device 802.

In an example, for purposes of network (e.g., cloud) backup and data security, computing device 802 additionally and/or alternatively synchronizes copies of application programs 814 and/or application data 816 to be stored at network-based server infrastructure 870 as application programs 876 and/or application data 878. In examples, operating system 812 and/or application programs 814 include a file hosting service client configured to synchronize applications and/or data stored in storage 820 at network-based server infrastructure 870.

In some embodiments, on-premises servers 892 are present in computing environment 800 and are communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 can be shared by on-premises servers 892 between computing devices of the organization, including computing device 802 (when part of an organization) through a local network of the organization, and/or through further networks accessible to the organization (including the Internet). Furthermore, in examples, on-premises servers 892 serve applications such as application programs 896 to the computing devices of the organization, including computing device 802. Accordingly, in examples, on-premises servers 892 include storage 894 (which includes one or more physical storage devices such as storage disks and/or SSDs) for storage of application programs 896 and application data 898 and include a processor 890 (e.g., similar to processor 810, GPU 842, and/or NPU 844 of computing device 802) for execution of application programs 896. In some embodiments, multiple processors 890 are present for execution of application programs 896 and/or for other purposes. In further examples, computing device 802 is configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 is used to implement systems, clients, or devices, or components/subcomponents thereof, disclosed elsewhere herein. In other embodiments, a combination of computing device 802, network-based server infrastructure 870, and/or on-premises servers 892 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) are stored in storage 820. Such computer programs can also be received via wired interface(s) 860 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### VI. Additional Example Embodiments

Systems, methods, and instrumentalities are described herein related to biometric authentication and personalization earbuds. Biometric authentication earbuds provide enhanced security and/or personalization for personal audio devices, such as a cell phone host device transmitting wireless audio information to the biometric authentication and personalization earbuds. Biometric authentication and personalization earbuds determine and use user-specific (e.g., unique) biometric markers, such as the shape of the inner and outer ear detected by pressure sensors, blood flow in the ear detected by photoplethysmography (PPG) sensors, and/or the ear's auditory response detected by acoustic sensors, to authenticate users, enable or adjust earbud operation(s) based on authentication, and/or personalize earbud operation(s) for users. For example, upon insertion, earbuds automatically authenticate the user by analyzing the user's biometric markers in comparison to one or more authenticated user biomarker profiles.

In one aspect, a method of user authentication for user authorization, identification, or access, comprises: generating pressure samples by a pressure sensor of the earbud inserted at least partially in an ear canal of an ear a first user; generating a first biometric marker from the pressure samples; generating a first comparison result based on a comparison of the first biometric marker with a first stored biometric marker associated with an authorized user of the earbud, the first stored biometric marker indicative of an in-car biometric profile of the authorized user; performing an authentication of the first user based at least on the first comparison result and/or performing a personalization of the ear bud based at least on the first comparison result.

According to another aspect, a system comprises an earbud configured to generate pressure samples by a pressure sensor of the earbud inserted at least partially in an ear canal of an ear a first user; generate a first biometric marker from the pressure samples; generate a first comparison result based on a comparison of the first biometric marker with a first stored biometric marker associated with an authorized user of the earbud, the first stored biometric marker indicative of an in-car biometric profile of the authorized user; perform an authentication of the first user based at least on the first comparison result and/or perform a personalization of the ear bud based at least on the first comparison result.

In examples, an earbud comprises: a pressure sensor configured to generate pressure samples when the earbud is inserted at least partially in an ear canal of an ear of a first user; a profiler configured to generate a first biometric marker from the pressure samples; a comparer configured to generate a first comparison result based on a comparison of the first biometric marker with a first stored biometric marker associated with an authorized user of the earbud, the first stored biometric marker indicative of an in-ear biometric profile of the authorized user; and an authenticator configured to perform an authentication of the first user based at least on the first comparison result.

In examples, the earbud further comprises: a heartbeat sensor configured to generate blood volume samples when the earbud is inserted at least partially in the ear canal of the first user, the heartbeat sensor configured to measure blood volume variation in the ear canal; the profiler configured to generate a second biometric marker from the blood volume samples; the comparer configured to generate a second comparison result based on a comparison of the second biometric marker with a second stored biometric marker associated with the authorized user, the second stored biometric marker indicative of an in-car blood volume profile of the authorized user; and the authenticator configured to perform an authentication of the user based at least on the first and second comparison results.

In examples, the earbud further comprises: an acoustic sensor configured to generate acoustic samples when the earbud is inserted at least partially in the ear canal of the first user, the acoustic sensor configured to measure acoustic reflections in the ear canal; the profiler configured to generate a second biometric marker from the acoustic samples; the comparer configured to generate a second comparison result based on a comparison of the second biometric marker with a second stored biometric marker associated with the authorized user, the second stored biometric marker indicative of an in-car acoustic profile of the authorized user; and the authenticator configured to perform an authentication of the user based at least on the first and second comparison results

In examples, the earbud includes an outer case portion and an inner case portion, the outer case portion configured to be positioned exterior to the ear canal in conjunction with the inner case portion being positioned in the ear canal. The inner case portion may comprise pressure sensors, including the pressure sensor, in at least a partial ring around a circumference of the inner case portion.

In examples, the earbud includes an outer case portion and an inner case portion, the outer case portion configured to be positioned exterior to the ear canal in conjunction with the inner case portion being positioned in the ear canal. The outer case portion may comprise pressure sensors that include the pressure sensor.

In examples, the earbud includes an inner case portion, an outer case portion, and a compression fitting formed by or coupled to the outer case portion, the compression fitting configured to contact a concha cymba of the ear of the user in conjunction with the inner case portion positioned in the ear canal and the outer case portion positioned exterior to the car canal. The compression fitting may be configured to transfer contact pressure from the concha cymba to the pressure sensor.

In examples, the authenticator is configured to perform an authentication comprises the authenticator configured to: authenticate the first user as the authorized user; and enable at least one function of the earbud.

In examples, the authenticator is configured to enable comprises the authenticator configured to perform at least one of: adjusting at least one audio setting of the earbud; or playing audio during a phone call on a device communicatively coupled with the earbud.

In examples, a method implemented by an earbud to perform biometric authentication and/or personalization for a user comprises: generating pressure samples by a pressure sensor of the earbud inserted at least partially in an ear canal of an ear of a first user; generating a first biometric marker from the pressure samples; generating a first comparison result based on a comparison of the first biometric marker with a first stored biometric marker associated with an authorized user of the earbud, the first stored biometric marker indicative of an in-car biometric profile of the authorized user; and performing an authentication of the first user based at least on the first comparison result.

In examples, the method may further comprise: generating blood volume samples by a heartbeat sensor of the earbud inserted at least partially in the ear canal of the first user, the heartbeat sensor configured to measure blood volume variation in the ear canal; generating a second biometric marker from the blood volume samples; generating a second comparison result based on a comparison of the second biometric marker with a second stored biometric marker associated with the authorized user, the second stored biometric marker indicative of an in-car blood volume profile of the authorized user; and performing an authentication of the user based at least on the first and second comparison results.

In examples, the method may further comprise: generating acoustic samples by an acoustic sensor of the earbud inserted at least partially in the ear canal of the first user, the acoustic sensor configured to measure acoustic reflections in the ear canal; generating a second biometric marker from the acoustic samples; generating a second comparison result based on a comparison of the second biometric marker with a second stored biometric marker associated with the authorized user, the second stored biometric marker indicative of an in-car acoustic profile of the authorized user; and performing an authentication of the user based at least on the first and second comparison results.

In examples, the earbud includes an outer case portion and an inner case portion, the outer case portion configured to be positioned exterior to the ear canal in conjunction with the inner case portion being positioned in the ear canal. The inner case portion may comprise pressure sensors, including the pressure sensor, in at least a partial ring around a circumference of the inner case portion.

In examples, the earbud includes an outer case portion and an inner case portion, the outer case portion configured to be positioned exterior to the ear canal in conjunction with the inner case portion being positioned in the ear canal. The outer case portion may comprise pressure sensors that include the pressure sensor.

In examples, the earbud includes an inner case portion, an outer case portion, and a compression fitting formed by or coupled to the outer case portion, the compression fitting configured to contact a concha cymba of the ear of the user in conjunction with the inner case portion positioned in the ear canal and the outer case portion positioned exterior to the car canal. The compression fitting may be configured to transfer contact pressure from the concha cymba to the pressure sensor.

In examples, performing an authentication may comprise: authenticating the first user as the authorized user; and enabling at least one function of the earbud.

In examples, enabling comprises at least one of adjusting at least one audio setting of the earbud; or playing audio during a phone call on a device communicatively coupled with the earbud.

In examples, a computer-readable storage medium is described herein. The computer-readable storage medium has program instructions recorded thereon that, when executed by a processor, implements a method, such as any method described herein. For example, an earbud may have program instructions recorded thereon that, when executed by a processor in the earbud, implement a method comprising: generating pressure samples by a pressure sensor of the earbud inserted at least partially in an ear canal of an ear of a first user; generating a first biometric marker from the pressure samples; generating a first comparison result based on a comparison of the first biometric marker with a first stored biometric marker associated with an authorized user of the earbud, the first stored biometric marker indicative of an in-car biometric profile of the authorized user; and performing an authentication of the first user based at least on the first comparison result.

In examples, the method may further comprise: generating blood volume samples by a heartbeat sensor of the earbud inserted at least partially in the ear canal of the first user, the heartbeat sensor configured to measure blood volume variation in the ear canal; generating a second biometric marker from the blood volume samples; generating a second comparison result based on a comparison of the second biometric marker with a second stored biometric marker associated with the authorized user, the second stored biometric marker indicative of an in-car blood volume profile of the authorized user; and performing an authentication of the user based at least on the first and second comparison results.

In examples, the method may further comprise: generating acoustic samples by an acoustic sensor of the earbud inserted at least partially in the ear canal of the first user, the acoustic sensor configured to measure acoustic reflections in the ear canal; generating a second biometric marker from the acoustic samples; generating a second comparison result based on a comparison of the second biometric marker with a second stored biometric marker associated with the authorized user, the second stored biometric marker indicative of an in-ear acoustic profile of the authorized user; and performing an authentication of the user based at least on the first and second comparison results.

In examples, the method may further comprise: performing a personalization of the ear bud for the first user based at least on the first comparison result.

### VII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

For example, running examples have been described with respect to malicious activity detectors determining whether compute resource creation operations potentially correspond to malicious activity. However, it is also contemplated herein that malicious activity detectors may be used to determine whether other types of control plane operations potentially correspond to malicious activity.

Several types of impactful operations have been described herein; however, lists of impactful operations may include other operations, such as, but not limited to, accessing enablement operations, creating and/or activating new (or previously-used) user accounts, creating and/or activating new subscriptions, changing attributes of a user or user group, changing multi-factor authentication settings, modifying federation settings, changing data protection (e.g., encryption) settings, elevating another user account's privileges (e.g., via an admin account), retriggering guest invitation e-mails, and/or other operations that impact the cloud-base system, an application associated with the cloud-based system, and/or a user (e.g., a user account) associated with the cloud-based system.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. An earbud, comprising:
a pressure sensor configured to generate pressure samples when the earbud is inserted at least partially in an ear canal of an ear of a first user;
a profiler configured to generate a first biometric marker from the pressure samples;
a comparer configured to generate a first comparison result based on a comparison of the first biometric marker with a first stored biometric marker associated with an authorized user of the earbud, the first stored biometric marker indicative of an in-ear biometric profile of the authorized user; and
an authenticator configured to perform an authentication of the first user based at least on the first comparison result.

2. The earbud of claim 1, further comprising:
a heartbeat sensor configured to generate blood volume samples when the earbud is inserted at least partially in the ear canal of the first user, the heartbeat sensor configured to measure blood volume variation in the ear canal;
wherein the profiler is configured to generate a second biometric marker from the blood volume samples;
wherein the comparer is configured to generate a second comparison result based on a comparison of the second biometric marker with a second stored biometric marker associated with the authorized user, the second stored biometric marker indicative of an in-ear blood volume profile of the authorized user; and
wherein the authenticator is configured to perform an authentication of the first user based at least on the first and second comparison results.

3. The earbud of claim 1, further comprising:
an acoustic sensor configured to generate acoustic samples when the earbud is inserted at least partially in the ear canal of the first user, the acoustic sensor configured to measure acoustic reflections in the ear canal;
wherein the profiler is configured to generate a second biometric marker from the acoustic samples;
wherein the comparer is configured to generate a second comparison result based on a comparison of the second biometric marker with a second stored biometric marker associated with the authorized user, the second stored biometric marker indicative of an in-ear acoustic profile of the authorized user; and
wherein the authenticator is configured to perform an authentication of the first user based at least on the first and second comparison results.

4. The earbud of claim 1, wherein the earbud includes an outer case portion and an inner case portion, the outer case portion configured to be positioned exterior to the ear canal in conjunction with the inner case portion being positioned in the ear canal;
wherein the inner case portion comprises pressure sensors, including the pressure sensor, in at least a partial ring around a circumference of the inner case portion.

5. The earbud of claim 1, wherein the earbud includes an outer case portion and an inner case portion, the outer case portion configured to be positioned exterior to the ear canal in conjunction with the inner case portion being positioned in the ear canal; and
wherein the outer case portion comprises pressure sensors that include the pressure sensor.

6. The earbud of claim 1, wherein the earbud includes an inner case portion, an outer case portion, and a compression fitting formed by or coupled to the outer case portion, wherein the compression fitting is configured to contact a concha cymba of the ear of the first user in conjunction with the inner case portion positioned in the ear canal and the outer case portion positioned exterior to the ear canal;
wherein the compression fitting is configured to transfer contact pressure from the concha cymba to the pressure sensor.

7. The earbud of claim 1, wherein said authenticator configured to perform an authentication comprises the authenticator configured to:
authenticate the first user as the authorized user; and
enable at least one function of the earbud.

8. The earbud of claim 7, wherein said authenticator configured to enable comprises the authenticator configured to perform at least one of:
adjusting at least one audio setting of the earbud; or
playing audio during a phone call on a device communicatively coupled with the earbud.

9. A method in an earbud, comprising:
generating pressure samples by a pressure sensor of the earbud inserted at least partially in an ear canal of an ear of a first user;
generating a first biometric marker from the pressure samples;
generating a first comparison result based on a comparison of the first biometric marker with a first stored biometric marker associated with an authorized user of the earbud, the first stored biometric marker indicative of an in-ear biometric profile of the authorized user; and
performing an authentication of the first user based at least on the first comparison result.

10. The method of claim 9, further comprising:
generating blood volume samples by a heartbeat sensor of the earbud inserted at least partially in the ear canal of the first user, the heartbeat sensor configured to measure blood volume variation in the ear canal;
generating a second biometric marker from the blood volume samples;
generating a second comparison result based on a comparison of the second biometric marker with a second stored biometric marker associated with the authorized user, the second stored biometric marker indicative of an in-ear blood volume profile of the authorized user; and
performing an authentication of the first user based at least on the first and second comparison results.

11. The method of claim 9, wherein further comprising:
generating acoustic samples by an acoustic sensor of the earbud inserted at least partially in the ear canal of the first user, the acoustic sensor configured to measure acoustic reflections in the ear canal;
generating a second biometric marker from the acoustic samples;
generating a second comparison result based on a comparison of the second biometric marker with a second stored biometric marker associated with the authorized user, the second stored biometric marker indicative of an in-ear acoustic profile of the authorized user; and
performing an authentication of the first user based at least on the first and second comparison results.

12. The method of claim 9, wherein the earbud includes an outer case portion and an inner case portion, the outer case portion configured to be positioned exterior to the ear canal in conjunction with the inner case portion being positioned in the ear canal;
wherein the inner case portion comprises pressure sensors, including the pressure sensor, in at least a partial ring around a circumference of the inner case portion.

13. The method of claim 9, wherein the earbud includes an outer case portion and an inner case portion, the outer case portion configured to be positioned exterior to the ear canal in conjunction with the inner case portion being positioned in the ear canal;
wherein the outer case portion comprises pressure sensors that include the pressure sensor.

14. The method of claim 9, wherein the earbud includes an inner case portion, an outer case portion, and a compression fitting formed by or coupled to the outer case portion, the compression fitting configured to contact a concha cymba of the ear of the first user in conjunction with the inner case portion positioned in the ear canal and the outer case portion positioned exterior to the ear canal;
wherein the compression fitting is configured to transfer contact pressure from the concha cymba to the pressure sensor.

15. The method of claim 9, wherein said performing an authentication comprises:
authenticating the first user as the authorized user; and
enabling at least one function of the earbud.

16. The method of claim 15, wherein said enabling comprises at least one of:
adjusting at least one audio setting of the earbud; or
playing audio during a phone call on a device communicatively coupled with the earbud.

17. A computer-readable storage medium in an earbud having program instructions recorded thereon that, when executed by a processor in the earbud, implement a method comprising:
generating pressure samples by a pressure sensor of the earbud inserted at least partially in an ear canal of an ear of a first user;
generating a first biometric marker from the pressure samples;
generating a first comparison result based on a comparison of the first biometric marker with a first stored biometric marker associated with an authorized user of the earbud, the first stored biometric marker indicative of an in-ear biometric profile of the authorized user; and
performing an authentication of the first user based at least on the first comparison result.

18. The computer-readable storage medium of claim 17, the method further comprising:
generating blood volume samples by a heartbeat sensor of the earbud inserted at least partially in the ear canal of the first user, the heartbeat sensor configured to measure blood volume variation in the ear canal;
generating a second biometric marker from the blood volume samples;
generating a second comparison result based on a comparison of the second biometric marker with a second stored biometric marker associated with the authorized user, the second stored biometric marker indicative of an in-ear blood volume profile of the authorized user; and
performing an authentication of the first user based at least on the first and second comparison results.

19. The computer-readable storage medium of claim 17, the method further comprising:
generating acoustic samples by an acoustic sensor of the earbud inserted at least partially in the ear canal of the first user, the acoustic sensor configured to measure acoustic reflections in the ear canal;
generating a second biometric marker from the acoustic samples;
generating a second comparison result based on a comparison of the second biometric marker with a second stored biometric marker associated with the authorized user, the second stored biometric marker indicative of an in-ear acoustic profile of the authorized user; and
performing an authentication of the first user based at least on the first and second comparison results.

20. The computer-readable storage medium of claim 17, the method further comprising:
performing a personalization of the ear bud for the first user based at least on the first comparison result.
